(19) United States
(12) Patent Application Publication
(10) Pub. No.: US 2026/0307903 A1
(43) Pub. Date: Oct. 8, 2026

(54) OPTIMIZING THE PROVISION OF CARGO AT AN ORDER-PICKING WORKSTATION OF AN INTRALOGISTICS SYSTEM

(71) Applicant: TGW Logistics Group GmbH, Marchtrenk (AT)

(72) Inventors: Gerald KETTLGRUBER, Linz (AT); Thomas POTRUSIL, Sankt Florian (AT)

(73) Assignee: TGW Logistics Group GmbH, Marchtrenk (AT)

(21) Appl. No.: 18/854,904

(22) PCT Filed: Apr. 6, 2023
(86) PCT No.: PCT/AT2023/060120

§ 371 Date: May 18, 2026

(30) Foreign Application Priority Data
Apr. 7, 2022 (EP) 22167173.8

(51) Int. Cl. B65G 1/137; B65G 47/68; G06Q 10/087

(52) U.S. Cl. CPC B65G 1/1373; B65G 47/684; G06Q 10/08741

(57) ABSTRACT

Computer-implemented method for optimizing the provision of unit loads at a picking workstation of an intralogistics system. Times for transporting unit loads from a buffer device to the picking workstation using a transport system are calculated. An expected picking performance of a picker at the picking workstation is also predicted. An optimized future provision sequence of unit loads upstream of the picking workstation and a unit load placement of the buffer positions are calculated on the basis of aforesaid information, with the result that neither jamming situations nor idling situations arise and an overall performance of the intralogistics system is consequently improved.

### BACKGROUND OF THE DISCLOSURE

Modern intralogistics systems, such as distribution centers of commercial organizations, for example, are highly complex plants with thousands, or even tens of thousands, of individual components, which interact technically with one another. Such components may be, for example, conveying devices, such as conveyor belts, sorters, intelligent rack systems, storage systems or other mechanical or electromechanical modules. Further, intelligent control systems for said components, as well as warehouse control systems (WCS), warehouse management systems (WMS) and material flow controls, are provided to control the complex procedures and functions.

The economic efficiency of intralogistics systems depends to a large extent on the effective interaction of the individual components. This applies, for example, to components relating to a storage and/or transport of unit loads on the one hand, and to components relating to the processing of picking orders at picking workstations on the other hand. In particular, this also relates to the desire for a capacity utilization of the picking workstations that is as effective as possible. Here, articles that pertain to a picking order and/or a customer order, for example, are compiled ready to dispatch and provisioned for later delivery. The individual articles of an order, which are described below as unit loads, are transported from a storage zone to the picking workstation via a conveying system and provisioned there for picking.

At the picking workstations, the picking orders are processed by a picker. A picker can be understood to be a human person or a machine picker, for example a picking robot. An individual picking performance of a picker, i.e. for example a time required to process a picking order of a certain scope, is usually subject to fluctuations over time. At the same time, multiple orders are often processed in parallel by the picker. Due to the complexity of the conveying system and/or complex picking orders with a plurality of articles, waiting times for the next unit load often occur, which can be accompanied by an idle time of the picker or also by jamming situations in front of the picking workstations. With regard to known technical attempts at a solution, the discussion in the prior art focuses on aspects of the optimized control of the components of intralogistics systems. For example, EP 3 385 893 A1 describes a method for controlling transport robots for unit loads for the partially or fully automatic operation of an intralogistics system.

Against this background, it would be desirable to achieve an overall improvement in the overall performance of the intralogistics system by optimizing the capacity utilization of pickers on the one hand and the other components of the intralogistics system on the other hand.

### OVERVIEW

It can therefore be regarded as an object of the invention to reduce fluctuations in a capacity utilization of pickers and/or improve a capacity utilization of plant components, for example in order to achieve a more effective processing of one or multiple orders by a picker. The subject-matters of the independent claims solve this problem.

The solution described below is based on the following considerations: A challenge in increasing the throughput of unit loads through an intralogistics system are fluctuations in performance over time, both of components of an intralogistics system relating to the storage and/or transport of unit loads and of pickers.

To this end, the intralogistics system comprises one or multiple picking workstations, a buffer device for temporarily storing unit loads, a conveying system for conveying unit loads between the buffer device and the picking workstation or the picking workstations, and a unit load manipulation unit for handing over the unit loads from the buffer device to the conveying system. Thus, unit loads can be provisioned and temporarily stored in the buffer device, handed over from the unit load manipulation unit to the conveying system and transported to one or multiple picking workstations by means of the conveying system.

Further, components of the intralogistics system can be, for example:
components for transporting articles, in particular a storage and retrieval system comprising one or multiple storage and retrieval units (RBGs), for example single-level storage and retrieval units (shuttles) and/or multi-level storage and retrieval units (stacker cranes), and/or a conveying system for transporting articles, such as, for example, a stationary conveying system, in particular an overhead conveying system and/or a ground-based conveying system, and/or a mobile conveying system, in particular autonomously displaceable transport vehicles, e.g. automated guided vehicles (AGVs) and/or autonomous mobile robots (AMRs),
components for sorting articles, such as, for example, sorting devices and suchlike,
components for processing (picking) orders, in particular automatic and/or manual workstations, for example picking workstations, packing stations, picking robots and suchlike,
components for handling articles, for example palletizers, depalletizers, gripping robots and suchlike,
components for storing articles, in particular storage locations for storing articles, which are provisioned, for example, by means of mobile storage racks, stationary storage racks and/or suchlike,
components for supporting articles, in particular loading aids, for example trays, containers, boxes, hanging bags for the suspended transport of articles and suchlike and/or
components for processing data, for example software components, control devices, in particular warehouse management system (WMS), warehouse control system (WCS), and suchlike. The unit loads preferably comprise a plurality of loading aids, which are configured to receive the goods and/or the articles.

A reduced performance can result, on the one hand, from idling situations, wherein, while a picker would be ready to execute a next picking work step after completing a preceding work step, the required unit load or unit loads do not arrive at the picking workstation in time via the conveying system. This causes idle times at the picking workstation, which can reduce an overall performance. A reduced overall performance can be caused, on the other hand, by jamming situations, where too many unit loads arrive at the picking workstation and cannot be processed sufficiently quickly by the picker there. This can result in unit loads having to be temporarily stored, for example in buffers or sequencers, which requires additional time and resources. This can in particular be the case as articles with different properties, for example with different haptic properties, volumes, weights, packaging sizes etc., cannot be picked with the same throughput.

To solve this problem, a computer-implemented method for optimizing a provisioning of unit loads at a picking workstation of an intralogistics system is therefore proposed. This method can advantageously reduce the jamming situations or idling situations described above in order to thus improve an overall performance of the intralogistics system and/or smooth fluctuations in a picking performance of a picker. A picking workstation can be understood to mean a workstation of a picker at which unit loads are removed, compiled and picked, for example from transport containers, in accordance with a picking order and then prepared for a later onward transport to the customer. The picker can in particular be a human picker who processes the picking order, in particular manually. Alternatively, the picker can be configured as a machine, for example as an automated or partially automated picking robot. Therefore, manual and/or (partially) automated picking workstations can be provided in the intralogistics system.

The intralogistics system has a buffer device with buffer positions for unit loads, and a unit load manipulation unit. Here, a buffer device has one or multiple buffer positions, at which one or multiple unit loads can be deposited and/or temporarily stored. In accordance with one example, buffer positions arranged above one another can form a buffer device. Here, each of these buffer positions can have one or a plurality of buffer locations located next to one another, wherein the buffer locations are configured to receive one unit load each. Here, each of the buffer positions is designed such that unit loads can be removed, in particular from each of the buffer locations. For further embodiment variants, reference is made to the description of the exemplary embodiments. Here, the buffer device can be arranged at different locations of the intralogistics system.

The unit load manipulation unit is in particular configured as a handover device between the buffer device and the conveying system and adapted for receiving unit loads from the buffer device and handing over unit loads to the conveying system. In this context, the unit load manipulation unit can be understood as a component for transporting articles, in particular as a storage and retrieval system comprising storage and retrieval units, for example single-level storage and retrieval units (shuttles) and/or multi-level storage and retrieval units (stacker cranes) if buffer locations of the buffer device are provisioned by a storage rack, for example. Preferably, the buffer positions are formed by provisioning devices, each of which is configured to take over unit loads from a storage and retrieval system, in particular from single-level storage and retrieval units, and hand over unit loads to a lifting device of the unit load manipulation unit. A provisioning device can be configured as a motor-driven conveying device (active provisioning device) or as a stationary supporting table without a motor-driven conveying device (passive provisioning device). The different embodiments are described, for example, in WO 2013/090970 A2.

The proposed method comprises a step of determining transport times of unit loads from a buffer position of the buffer device to the picking workstation of the intralogistics system, wherein in particular a transport of the unit loads is simulated. More specifically, the simulating is performed using a simulation unit comprising, for example, a model image of the intralogistics system for the purpose of calculating transport times. The simulating of such complex systems is performed in the simulation unit using suitable software-based simulation systems. In other words, the simulation unit calculates resultant total times which a unit load requires from the pick-up from a buffer position to the arrival at the picking workstation, taking into account the known partial transport time models and/or measured time data of unit loads through the conveying system and through other components of the intralogistics system under various boundary conditions.

In accordance with one example, the simulation unit can calculate a plurality of transport times for one and the same unit load in various scenarios, for example order constellations. It can be regarded as a concept of the invention that the buffer position is now included in an overall simulation of the intralogistics system. In this context, the term buffer position can in particular also comprise one or multiple buffer locations of this buffer position. While the solutions known in the prior art describe the simulation of sub-regions of intralogistics systems, these simulations are often restricted to the conveying system, as transport times therein can be forecast with small variances and sufficient accuracy due to their defined time characteristics. Here, the variances are in the range of a few seconds, for example.

At the same time, the processes in the storage zone are subject to considerably greater time variances of often more than 30 seconds up to several minutes due to the warehouse organization, warehouse structure and the long transport routes within the storage zone, so that a simulation allows only insufficiently accurate forecasts in the context of the overall intralogistics system. It is therefore one concept of this invention to considerably improve the time forecasting by making intelligent use of a buffer device in proximity to the conveying system. In other words, the introduction of the buffer device enables an uncoupling, in simulation, of the storage zone and the conveying system, wherein the advantage of a more accurate forecast of the actual transport times of unit loads to the picking workstation is achieved.

In another step, a determining of a picking performance to be expected of the picking workstation is performed using the simulation unit. A picking performance can be described, for example, as orders per unit of time, number of unit loads per unit of time, articles per unit of time and is to describe a performance of a picker, for example of a human picker or of a corresponding machine picking robot. In this context, a picking performance to be expected means, for example, a future picking performance that will be achieved with a specific probability, which can then be used as a basis for calculations and simulations. This can also mean a distribution of different performance levels over a specific period of time. In accordance with one example, the determining of a picking performance to be expected of the picking workstation is performed without a simulation unit, for example on the basis of statistical and/or historical data.

In another step, a calculating of a future provisioning sequence of unit loads with the respective points in time of provisioning of the unit loads at the picking workstation is performed on the basis of a previously determined picking performance of the picker. Here, the provisioning sequence means, for example, a specific sequence of unit loads, for example transport containers, which are conveyed to a picking workstation in sequential succession and then provisioned, there, to a picker in this sequence in a waiting queue. The point in time of provisioning can be understood to mean a relative or absolute specification of time in relation to a specific unit load at which this unit load is available or is to be available for a picking work step. A unit load can also be understood as a plurality of unit loads, transport containers, articles or suchlike.

Here, the calculating is performed such that, at the picking workstation, an amount of a time difference between the point in time of a conclusion of a picking work step for a unit load and the point in time of the arrival of the next unit load at the picking workstation is minimized. In other words, this is to prevent both a jamming situation, where too many unit loads are waiting at the picking workstation (container jam) and cannot be processed sufficiently quickly by the picker, and an idling situation, in which a picker must wait for the arrival of the next unit load at the picking workstation. Both said cases are unfavorable situations from the perspective of an overall performance of the intralogistics system. The minimizing of this time difference can be understood as an optimizing function with regard to an ideal of a maximum possible performance of the picking workstation in relation to the provisioning of unit loads. In other words, a distribution over time of a picking performance of a picker is smoothed.

In another step, a calculating of a unit load placement of the buffer positions of the buffer device with the associated points in time of provisioning is performed by the simulation unit and based on the determined transport times of the unit loads through the intralogistics system to the picking workstation. Here, the calculating is performed such that it results in the previously calculated provisioning sequence with the points in time of provisioning for unit loads at the picking workstation. This means that, if an optimal provisioning sequence together with the corresponding points in time of provisioning for the picking workstation is available, this can be used to reverse calculate the required placement of unit loads of the buffer positions and/or of the buffer locations of the buffer device and also the associated points in time or periods of time using the simulation of the intralogistics system.

For the purpose of a proper understanding, a distinction must therefore be made between the provisioning of unit loads in front of a picking workstation and the making available of unit loads at the buffer positions of the buffer device. Such a unit load placement with the associated availability times can mean in a specific case that, for example, a unit load L1 must be deposited at a specific buffer location P3 at an absolute point in time t1 at the latest, for example 11:33:30 hrs., so that a unit load manipulation unit can subsequently receive the unit load L1 and transport it further using the conveying system. In accordance with one example, the availability time can specify an earliest or latest point in time or also a period of time in which a unit load was transported to a buffer location and/or buffer position and deposited there, for example by an intra-warehouse transport system.

In one embodiment, the provisioning sequence is calculated, so that a number of unit loads of the same order to be provisioned in direct succession at the picking workstation is maximized if the order comprises articles from multiple unit loads, for example. In this manner, a time for processing one and the same order by a picker can advantageously be shortened. This is based on the concept that the provisioning sequences in solutions in the prior art alternately contain unit loads for different orders, and consequently orders at the picking workstation cannot be concluded as unit loads or articles received by unit loads must be waited for. Consequently, this results in longer order processing times, which can be shortened by targeted sequencing of unit loads belonging together. In addition, transport times of unit loads can be minimized as the unit loads need not execute any waiting rounds on the conveying system or be temporarily rerouted to a sequencer or separate buffer. Another approach can be that, instead of the sequencing of unit loads for larger orders (retail and grocery), individual orders are compiled into an optimized sequence. Individual orders can be understood to mean, for example, e-commerce orders, which often comprise only a single article.

In one embodiment, the determining of a future picking performance of the picking workstation is performed by forecasting using the simulation unit. In accordance with one example, historical picking performance data can be used to calculate future picking performances using suitable calculation methods such as interpolation or regression models. In accordance with another embodiment, the forecasting is based on an analysis of a development over time of an actual picking performance of the picking workstation. In other words, specific historical periods of time and developments over time of the performance of the picker, i.e. of actual historical picking performances, can be evaluated. As an advantage, a more realistic prognosis can be made as a performance profile of one and the same picker, as a rule, is subject to smaller fluctuations and can therefore be projected into the future with good accuracy.

In one embodiment, the forecasting of the picking performance is performed on the basis of picking performance profiles, for example using an acquisition unit for picking performance profiles. A picking performance profile can be understood to mean, for example, a typical development over time of a picking performance of a picker, in particular of a corresponding machine picking robot. Such a picking performance profile can map, for example, fluctuations in a picking performance during a workday, optionally also taking break times and suchlike into account. One advantage of such a picking performance profile can be a simplified integrated assignment of the corresponding performance items to a picker. In accordance with one example, a generating of a picking performance profile is performed by evaluating historical performance data, in particular combined with article metadata, for example weight, volume, article description, packing densities per compartment and a time dimension. These data can be based, for example, on sources in different intralogistics systems. This may also relate to intralogistics systems of different customers and/or sites.

In accordance with this embodiment, the picking performance profiles are generated using a trained model of machine learning (machine learning model and/or MLM), in particular using a trained artificial neural network. In accordance with one example, predefined picking performance profiles which are suitable for a classification using a model of machine learning are defined in advance. A model of machine learning prepared with this training data then assigns the currently acquired picking performance data, for example by classification, to one of the provisioned picking performance profiles.

In one embodiment, this is performed in the method presented by the step of selecting a picking performance profile by classifying the picking performance data using a trained model of machine learning, in particular using a trained artificial neural network.

In one embodiment, the selecting is performed such that a deviation of the selected picking performance profile from the development over time of the actual picking performance is minimized. In other words, a picking performance profile can also be selected by selecting the picking performance profile in which the total of all deviations between the respective discrete performance values as determined by an intelligent evaluation function is the lowest, for example. In accordance with one example, this can be done using a selection unit for picking performance profiles.

In one embodiment, the method further comprises the step of creating a manipulation specification for a control unit of the unit load manipulation unit for receiving unit loads from the buffer positions of the buffer device and delivering unit loads to the conveying system for conveying unit loads to the picking workstation. In other words, the manipulation specification can be understood, for example, as a command or set of commands along with control information for a lift at a rack system, which then moves to a specified buffer position or buffer location of the buffer device at a defined point in time and receives the unit loads there, conveys the unit loads onward and then deposits the unit loads on a conveying system for the unit loads to be transported onward toward a picking workstation.

The manipulation specification can be generated, for example, by a control unit of the intralogistics system. In accordance with one example, the manipulation specification can comprise different specifications for the unit load manipulation unit such as, for example, in relation to speed, acceleration, buffer location information, buffer position information, information on the handover point to the conveying system, additional specifications on the unit loads, weight and suchlike. In other words, the creating of the manipulation specification, in accordance with one embodiment, comprises a generating of a start signal for the control unit of the unit load manipulation unit for receiving a unit load from one of the buffer positions of the buffer device and/or changing a dynamic of the unit load manipulation unit and/or changing or specifying a moving sequence for the buffer positions.

In accordance with one embodiment, the method further comprises a step of provisioning the calculated unit load placement of the buffer positions and/or buffer locations of the buffer device with the associated points in time of provisioning to a control unit for transport vehicles of the intralogistics system. In accordance with one example, these transport vehicles of the intralogistics system can be conveying means of a storage area or storage zone. The uncoupling of the storage zone and the conveying system as described above can advantageously create the possibility for a control entity operating at least partially independently of the rest of the intralogistics systems to be provided in the storage zone. With the time variances being considerably greater in the storage zone in comparison to the conveying system of the intralogistics system, it may be necessary to provide a separate logistics and control system.

To achieve the smoothing of a capacity utilization of pickers aimed at with this solution, and generally an optimal capacity utilization of the other components of the intralogistics system, the relevant unit load must be available at the buffer devices at the right point in time and/or in the right period of time and optionally be picked up and/or passed on. The storage area can provision a separate control system for the question of the lead time and transport operations required to that end. In other words, in accordance with the embodiment discussed here, the control unit for transport vehicles of the intralogistics system is configured to control a retrieval of unit loads from storage locations of a storage area such that the unit load is available at the calculated buffer positions and/or buffer locations at the calculated points in time of occupation and can therefore be passed on, for example. In accordance with one example, this principle described can be analogously applied to the process of storing unit loads in storage locations of a storage area. Here, the flow of unit loads is in the opposite direction, from the picking workstation toward the storage area. Here, unit loads can also be deposited on buffer positions and be picked up and stored in a storage rack again by a provisioning conveyor in a subsequent step.

In one aspect of the invention, an intralogistics system is proposed having a storage area for unit loads, a plurality of transport vehicles operated in an automated manner, a buffer device with a plurality of buffer positions for receiving unit loads previously retrieved from the storage area, a unit load manipulation unit, a conveying system, a picking workstation and a simulation unit. This simulation unit is adapted for simulating and/or determining transport times of unit loads from a buffer position of the buffer device to a picking workstation of the intralogistics system. In accordance with one example, the picking workstation is adapted for picking electronically acquired orders.

This intralogistics system is configured to execute the method as described above. The transport vehicles are adapted for transporting unit loads between the storage area and the buffer positions and/or buffer locations. Such transport vehicles can be, for example, storage and retrieval systems such as storage and retrieval units, shuttles and/or so-called stacker cranes, and also a conveying system for transporting articles, such as, for example, an overhead conveying system and/or ground-based conveying system, and/or mobile conveying system, such as autonomously displaceable transport vehicles. The unit load manipulation unit configured to receive a unit load from a buffer position of the buffer device and hand the unit load over to the conveying system for onward transport.

The conveying system is adapted for transporting unit loads between the unit load manipulation unit and the picking workstation.

In one embodiment, the buffer device is arranged at the unit load manipulation unit on the side of the storage area. In other words, the buffer device in this example is located close to or in front of the lift at a rack system by the storage zone. This means that the buffer device in this embodiment is advantageously arranged at a functional handover point from the storage zone to the conveying system. From the perspective of a simulation of the intralogistics system, the buffer device is therefore located at the start of a conveying route toward the picking workstation, so that no traveling on the conveying system is required before the buffering.

In one embodiment, the unit load manipulation unit has a unit load lifting device. In other words, what is meant here is a lift, for example in the sense of a storage and retrieval unit which can receive unit loads from a buffer device located higher up and move the unit loads in a vertical direction. In an advantageous manner, one buffer device per vertical rack level, for example, can thus be provided, in which unit loads can be placed concurrently. In accordance with one example, a unit load lifting device can consequently access a plurality of buffer devices.

In one embodiment, the buffer device is configured such that the unit load manipulation unit can access each buffer location and/or each buffer position of the buffer device at a given point in time. In other words, in contrast to the first in, first out (FIFO) principle, an optional access to any of the buffer locations or buffer positions is advantageously enabled here. Therefore, it is to be avoided that, like in the FIFO principle, unit loads must first be moved in order to be able to access and receive a specific unit load. It should be noted that some of the possible features and advantages of the invention are described herein in relation to different embodiments. A skilled person will see that the features can be combined, adapted or replaced in a suitable manner in order to arrive at other embodiments of the invention.

Below, embodiments of the invention are described with reference to the enclosed drawings, wherein neither the drawings nor the description are to be construed as limiting the invention.

### BRIEF DESCRIPTION OF THE FIGURES

FIG. 1 shows a simplified intralogistics system with selected components in accordance with the prior art;

FIG. 2 shows a development over time of a picking performance of a picker, of a provisioning of unit loads at a picking workstation and of a resultant overall performance in accordance with the prior art;

FIG. 3 shows a simplified intralogistics system with buffer positions and unit load manipulation units in accordance with the invention;

FIG. 4 shows a method in accordance with the invention for optimizing a provisioning of unit loads at a picking workstation of an intralogistics system;

FIG. 5 shows an example of a buffer device in accordance with the invention with three buffer positions and buffer locations;

FIG. 6 shows a buffer position with two buffer locations and a unit load manipulation unit;

FIG. 7 shows a picking workstation with a picker and conveying system;

FIG. 8 shows a simulation unit for calculating transport times of unit loads;

FIG. 9 shows a simulation unit for calculating a picking performance to be expected with an AI module.

The figures are merely schematic and not to scale. Equal reference numbers in the different figures designate equal features, or features having the same effect.

### DETAILED DESCRIPTION OF THE EMBODIMENTS

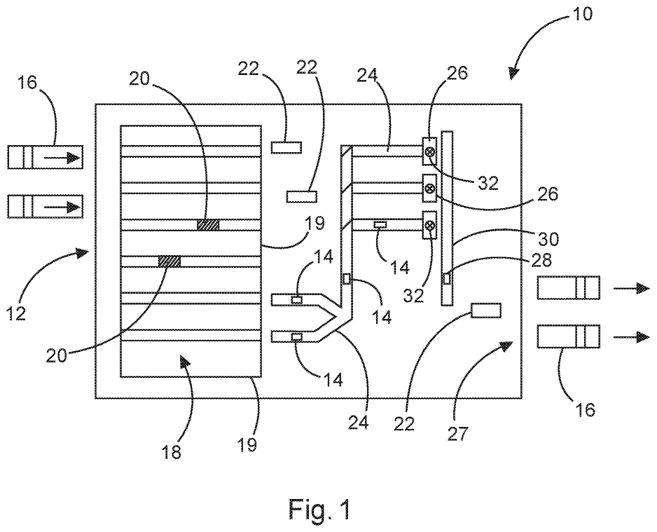

FIG. 1 shows an intralogistics system 10, which can be configured as a distribution center for different articles. The intralogistics system 10 shown comprises a rack system 18 for storing the articles, wherein the articles can be provided in transport containers, which are described below as unit loads 14. Further provided are picking workstations 26 for processing previously electronically acquired orders and a storage and/or retrieval system, which connects the rack system 18 and the picking workstations 26 in terms of conveyance. The rack system 18 has a plurality of storage racks 19 (components for storing articles and/or unit loads 14) installed in a stationary manner. The storage and/or retrieval system comprises one or multiple storage and retrieval units 20, as well as a mobile conveying system 22, for example AGVs and/or AMRs, and/or a stationary conveying system 24 (components for transporting articles/unit loads 14) in order to store unit loads 14 in the storage racks 19 or retrieve unit loads 14 from the storage racks 19, and in order to transport the unit loads 14 between the rack system 18 and the workstations 26.

Further, a goods receipt 12 is provided, where articles (not shown in FIG. 1) are delivered using delivery vehicles 16. These articles can be stored in the rack system 18 as unit loads 14, for example. In accordance with the example shown, the picking workstations 26 are provided for picking articles in accordance with the acquired orders. At these workstations, so-called pickers 32, i.e. manually operating pickers or automatically operating pickers, in particular picking workers or picking robots, are operating, who/which remove goods or articles, for example, from the unit load 14, for example a transport container, and compile the goods or articles into shipping packages in accordance with the specified orders. To this end, unit loads 14 are provisioned at a workstation 26 by means of the conveying system 22, 24 and loaded into target loading aids, in particular into a shipping package 18.

The readily picked and packaged articles/unit loads 14 can be transported from the picking workstations 26 to the goods issue 27 with a (mobile and/or stationary) outbound conveying system 30. There, the shipping packages 28, in turn, are received and transported away by delivery vehicles 16. As a rule, such intralogistics systems 10 are highly complex and have a plurality of most varied components. The interaction of all components is crucial for a high throughput and the demanded productivity. Here, a well-coordinated interaction between the supply of unit loads 14 to the picking workstations 26 and a processing of orders by the picker 32 there is essential.

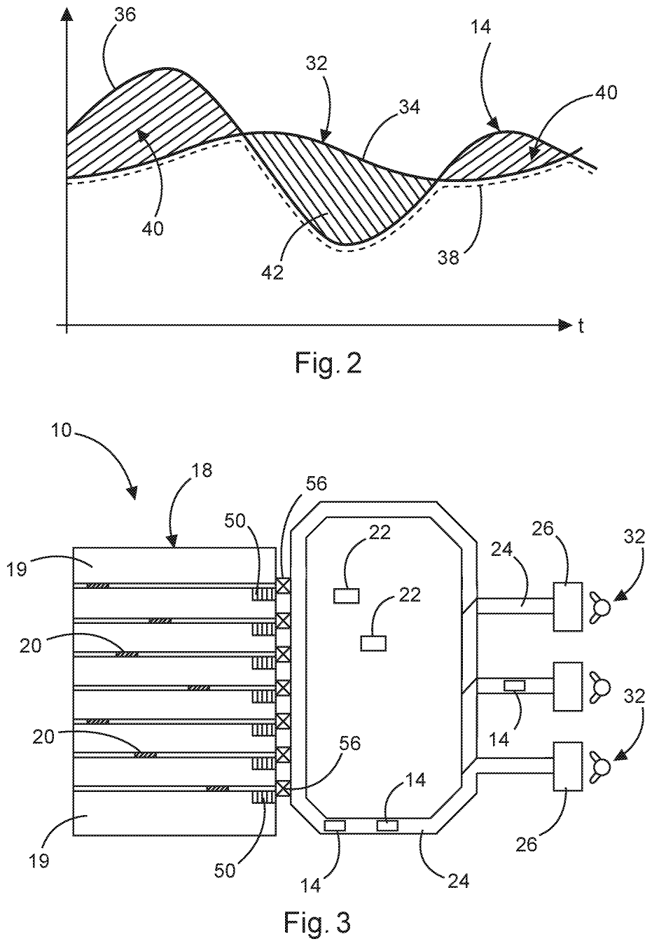

In FIG. 2, a development over time of a picking performance 34 of a picker 32 relative to a number of unit loads 14 in a waiting queue in front of the picking workstation 26 of the picker 32 is represented in this context by way of example. The difficulty in the practical operation of an intralogistics system 10 is that, due to the complexity of the components of the intralogistics system 10, in particular due to the high number of different articles/unit loads 14, the very different transport routes and transport times and other influencing factors, a supply of unit loads 14 at the picking workstation 26 can be subject to fluctuations over time. In addition, there is a time variance of a picking performance 34 of a picker 32 due to typical human influencing factors such as time of day, individual performance, motivation and suchlike. In the case in which a picker is formed by an automated or partially automated picking robot unit and/or picking robot, the influencing factors can be exclusively or predominantly constituted by metadata of the article (unit load). Both curves, i.e. the development over time of the picking performance 34 of a picker 32 and the development over time 36 of the number of unit loads 14 in a waiting queue in front of the picking workstation 26 of the picker 32, have different characteristics, so that, overall, there is a resultant performance 38 which results from the smaller of the two performance values, i.e. picking performance 34 and provisioning performance 36, respectively.

Generally, this results in two constellations which are potentially problematic for an overall performance of the system. On the one hand, a jamming situation 40 can occur, in which too many unit loads 14 are waiting in front of a picking workstation 26. In other words, in this situation, a current picking performance 34 of a picker 32 is lower than a provisioning performance 36 of unit loads 14 in front of the picking workstation 26. Another problematic constellation can result whenever there is an idling situation 42, in which too few unit loads 14 are available at the picking workstation 26 and the picker must wait for the next unit load 14.

In other words, in this case, a provisioning performance 36 of unit loads is lower than a picking performance 34 of a picker 32 at this point in time. It can be seen from the curve represented in FIG. 2 that a resultant performance 38 of the overall system can be improved by equalizing the two developments over time of the provisioning performance 36 and of the picking performance 34 of the picker 32, wherein this is ideally performed such that precisely as many unit loads 14 as a picker 32 can process in accordance with his picking performance 34 at this point in time are available at the picking workstation 26.

To his end, in accordance with the simplified intralogistics systems 10 represented in FIG. 3, buffer devices 50 are provided, which, from a logistics perspective, are arranged at the transition from the area of the rack systems 18 to the conveying system 24 and/or to the mobile transport system 22 in the example shown here. These buffer devices 50 (in this context see FIG. 5 and FIG. 6) each have buffer positions 52 and these buffer positions 52, in turn, optionally have one or multiple buffer locations 54. Here, the buffer positions 52 are located, for example, between the respective unit load manipulation units 56 configured as lifts, for example, which are arranged in front of the rack system 18 and/or of the storage racks 19, and the transport vehicles, in this case the storage and retrieval units 20. Other constellations and/or access options of the unit load manipulation units 56 to the buffer positions will be explained in more detail below. Otherwise, the components of the intralogistics system 10 represented in FIG. 3 correspond to the components already represented in FIG. 1. The storage racks 19 are represented in FIG. 1 and FIG. 3 in a top view.

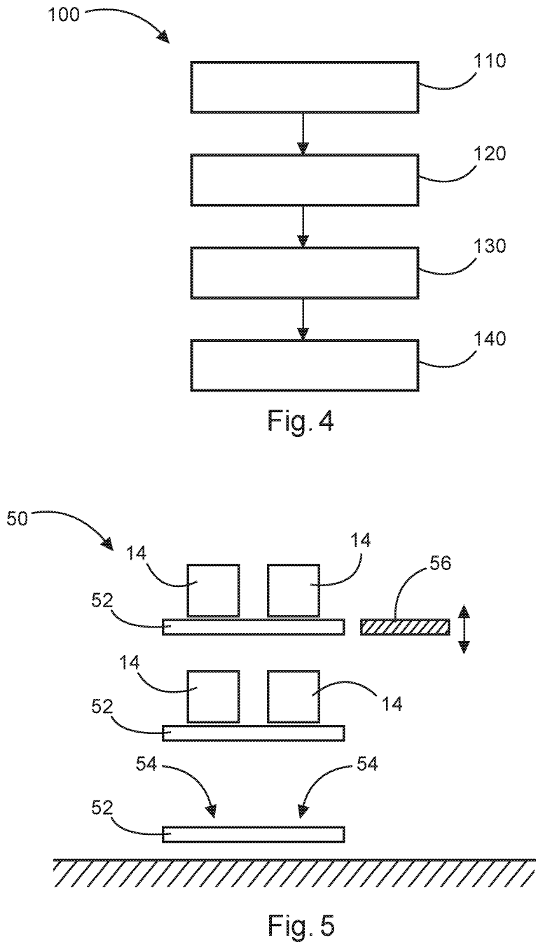

To achieve improvements of a resultant performance 38 of the intralogistics system 10, the method 100 represented in FIG. 4 in accordance with the invention is proposed, which will be described in more detail in the figures below. To this end, the intralogistics system 10 comprises a buffer device 50. In a step 110, a determining of transport times of unit loads 14 from a buffer position 52 of the buffer device 50 to the picking workstation 26 of the intralogistics system 10 is performed. In accordance with one example, these can be a plurality of transport times due to most varied scenarios and boundary conditions.

In another step 120, a picking performance 34 to be expected of a picker 32 is determined using a simulation unit 44. Here, a picking performance 34 of a picker may in particular depend on the time of day, for example with a higher picking performance 34 in the morning and a lower picking performance 34 in the afternoon. In accordance with one example, this can be performed using statistical/mathematical methods such as interpolation, regression models or also using trained machine learning models, in particular artificial neural networks, while including the above-mentioned data and boundary conditions.

In accordance with one example, real data from different customer plants are used for an estimation of the picking performance 34. Such real data comprise, for example the picking time which was required by a specific picker 32 for processing an order with a specific number of articles. Further, a point in time, for example a specific time, but also metadata of the article (unit load) such as weight, dimension, volume or surface properties can be described. Based on this data, a descriptive statistical distribution model in relation to a picking performance 34 of a picker 32 can be drawn up for each article or article group. In accordance with one example, descriptive statistical parameters, in particular average values, minimum values or maximum values are calculated to this end.

As described before, the picking performance 34 to be expected can also be determined from historical data. Such historical data can relate, for example, to information indicating the picking performance of the past, such as, for example, number of the objects or articles which are reloaded from one container into another container. This number is also described by the term pick and/or picks. Also the time which was required for processing a picking order can be acquired, and also the number of errors that were made, for example wrongly picked up or deposited objects, or also objects that were dropped.

When the picking is performed by a robot or another device, further historical data may be relevant, such as, for example, how easily an object was able to be picked. This can also be indicated, for example, by a number of drops, how often an object was wrongly picked or an average picking time, i.e. how long it took to pick an object. This can be stored for different or diverse objects.

For objects or articles for which there is no specific history, deduction by similarity can be applied, i.e. objects which have similar measurements, weights, surface properties, etc. can be included in the determining step. These properties are also stored in article metadata. Also the composition of the container can play a role, as a robot can pick more quickly from a container with only two articles than from a container with twenty articles. This is because, on the one hand, it is easier to identify the article and/or articles and also the mechanic gripping operation is easier with fewer articles. In mixed containers, i.e. containers in which different or diverse articles are stored jointly, picking can be more difficult and the error rate could increase.

If the picking is performed by a person, the considerations just described also apply, but additional aspects come into play. The picking performance of a person can vary over time. For example with respect to the time of day, so that the picking performance for a specific human picker is better or worse in the morning, e.g. at the start of a shift, than in the afternoon, e.g. at the end of a shift. The picking performance can also depend on the day of the week, so that the performance on Monday is better or worse than on Friday. Also, the performance can be better or worse before a bank holiday or vacation day than after such a day. Furthermore, the picking performance can also be different after a time change compared to the time before the change. Finally, also the ergonomics of the picking station can play a role. The same person can perform better at a height-adjustable station than at a station that is not height-adjustable. Or a smaller person always performs worse at a specific station, as the containers are not supplied within reach. Ultimately, also the level of experience of a person can play a role, as an experienced person can perform greater than an inexperienced person.

The examples explained above are not exhaustive and can be available both as part of the historical picking data 64 and as a picking performance profile 66. The considerations described can furthermore be used when determining the picking performance to be expected.

‘Picking’ can be understood to mean picking up an article or object by the picker, for example from a container, and optionally depositing the picked up article or object, for example in another container, in particular reloading an article from one container into another container, preferably in accordance with a picking order.

In a step 130, a calculating of a future provisioning sequence of unit loads 14 with the respective points in time of provisioning of the unit loads 14 at the picking workstation 26 is performed. Here, the calculating is performed such that, at the picking workstation 26 an amount of a time difference between a point in time of a conclusion of a picking work step by a picker 32 for a unit load 14 and the point in time of the arrival of the next unit load 14 at the picking workstation 26 is minimized. With reference to FIG. 2, the differences between the two curves described by either an idling situation 42 or a jamming situation 40 are thus reduced or minimized, whereby an overall performance of the intralogistics system 10 is improved.

Here, step 130 can be controlled from the perspective of optimizing the provisioning sequence, which has as an optimization goal as stable as possible a supply to the workstations, i.e. that neither a jamming of articles nor an idling is to occur at the station, for example. This corresponds to the above-mentioned minimizing of the differences. The aim here can also be a minimizing of the processing time of an order, so that a mixed processing, i.e. an order is started and is finished only later, after a plurality of other orders was started and finished, is avoided. Also ergonomics at the picking station can be taken into account, so that, with respect to the handling of the articles, as varied a picking as possible is achieved, so as to avoid all heavy articles within an order arriving first and all light articles within the order arriving subsequently. Finally, also a specific sequence can be specified, such as, for example, all heavy articles first, as these will then be located at the bottom of a package to be packed, for example, and all the light articles subsequently.

In a step 140, a calculating of a unit load placement of the buffer locations 54 and/or the buffer positions 52 of the buffer device 50 with the associated points in time of provisioning is performed, resulting in the calculated provisioning sequence with the points in time of provisioning at the picking workstation 26. In accordance with one example, a creating of a manipulation specification for a control unit of the unit load manipulation unit 56 for receiving unit loads 14 from the buffer positions 52 or buffer locations 54 of the buffer device 50 and delivering unit loads 14 to the conveying system 22, 24 is performed. This can comprise a generating of a start signal (transport release) for the control unit of the unit load manipulation unit 56. In other words, this control signal can be understood as a start signal, which notifies a lift, for example, as to the speed, dynamic and/or point in time with/at which the lift is to receive a unit load 14 at a specific buffer location 54 and pass on the unit load 14 to a mobile or stationary transport system 22, 24.

Here, both the step 140 and the step 130 can be executed by the simulation unit 44 using an AI module 68 described later on, such that reinforcement learning is used, for example. Here, the simulation is started without further specifications and a good result is rewarded. Optionally, it is also possible to penalize worse results, so that the AI module learns independently which optimization parameters are desired for a good outcome of the simulation.

Alternatively, step 140 can also be executed using a backward simulation already described above, in which it is backward simulated, starting from an optimal result, which articles must be available at what point in time, and these articles are sorted into the storage area backwards, as it were, via their transport routes. In this manner, it can be ensured that the sequence of the retrieval from the buffer device 50 corresponds to the sequence in which the articles are required at the picking station.

FIG. 5 and FIG. 6 show a buffer device 50 with three buffer positions 52 arranged above one another. One or multiple buffer locations 54 can be arranged at each buffer position 52. In the example in accordance with FIG. 5, which represents a side view, 3 buffer positions 52 arranged above one another form a buffer device 50. Each of these buffer positions 52 can be reached by the unit load manipulation unit 56. This means that the unit load manipulation unit 56 can access each buffer location 54 and/or each buffer position 52 of the buffer device 50 at a given point in time.

In the example represented in accordance with FIG. 5, the buffer locations 54 are arranged in succession toward the unit load manipulation unit 56 and therefore accessible according to the FIFO principle. Alternatively, in accordance with the embodiment variant represented in a top view in FIG. 6, it can be provided that the unit load manipulation unit can directly access each of the individual buffer locations 54 of the buffer position 52. In accordance with one example, a lift as an embodiment variant of a unit load manipulation unit 56 can also be configured narrower and can be displaceable in a horizontal direction, so that only one unit load 14 is received widthwise.

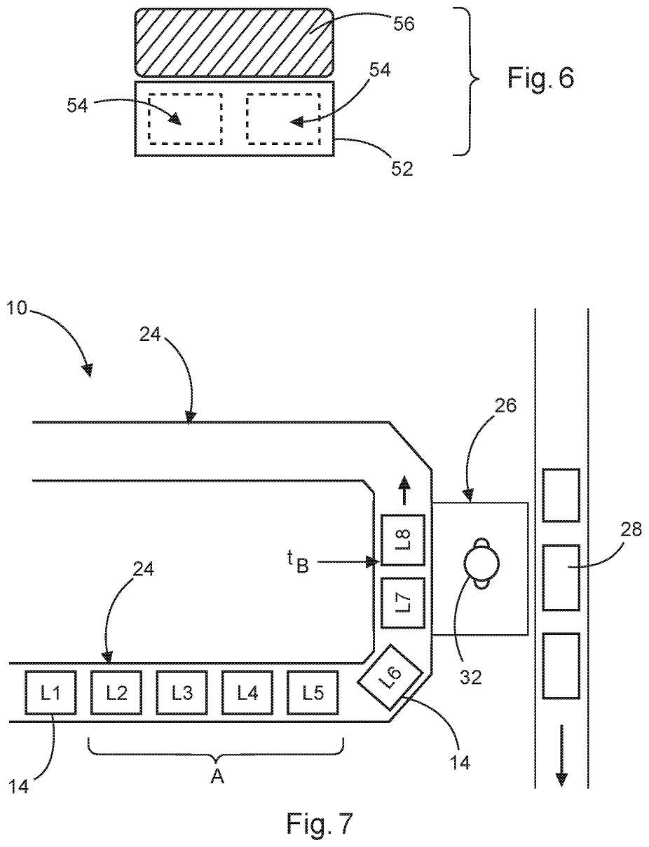

FIG. 7 shows an example of a partial area of an intralogistics system 10. A stationary transport system 24 transports unit loads 14, i.e. for example a series of transport containers, to a picking workstation 26 with a picker 32. In accordance with a previously acquired order, this picker 32 assigns articles from the unit loads 14, which are made available directly in front of the picking workstation 26 by the stationary transport system 24, to a shipping package 28, which has been provisioned at an outbound conveying system 30.

Each completed article transaction into the shipping package 28 is confirmed by a transaction confirmation signal, initiated by the picker 32, to a central picking data processing system. Once an order is concluded, the entire shipping package 28 is transported to a goods issue 27 (not shown here) with the outbound conveying system 30. It can be seen that a sequence of unit loads 14 is transported toward the picking workstation 26 in succession. Unit loads L1 to L8 are shown here by way of example, wherein the unit loads can each be assigned to different orders.

One concept of the invention can be seen in that, by intelligent starting of the transport of the respective unit load 14 from a buffer device 50 or by a start signal of a unit load manipulation unit 56 and by controlling the sequence of the starts, an optimized sequence of unit loads 14 is created in front of the picking workstation 26. In the specific example, the unit loads L2, L3, L4 and L5 provisioned in direct sequential succession belong to a (joint) order A. As a consequence, the picker 32 can process and finalize a complete order in succession by processing the unit loads L2 to L5 and the duration of an order processing operation can thereby be reduced. After passing the picking workstation 26, the unit loads 14 are directed back to the rack system 18, for example, via the transport system 22, 24 referred to as source loop.

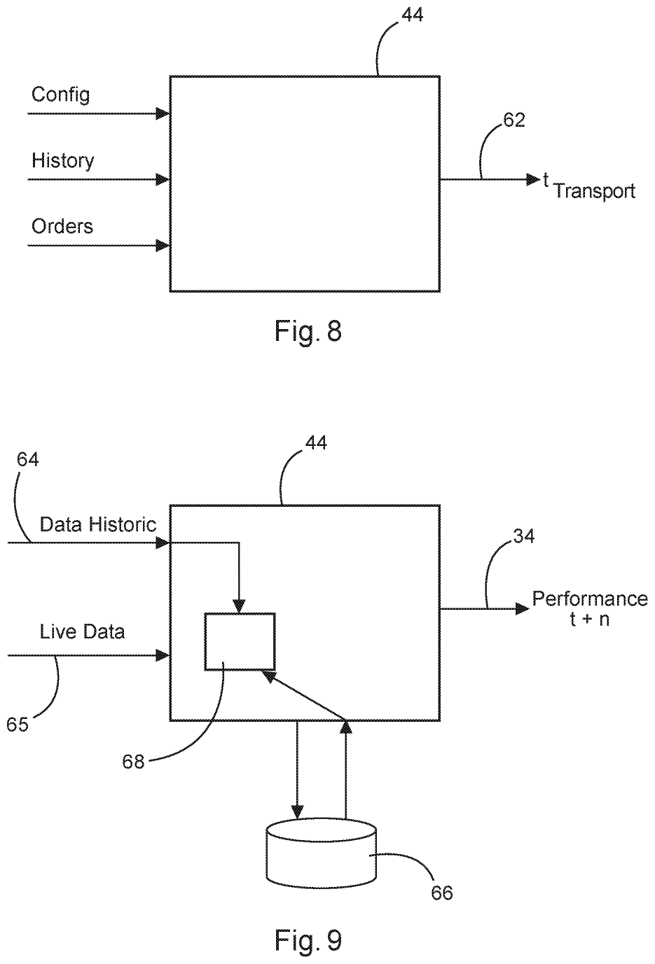

FIG. 8 shows a simulation unit 44 for determining transport times of unit loads 14 from a buffer position 52 or buffer location 54 of a buffer device 50 to a picking workstation 26. The simulation unit 44 is configured to calculate a plurality of possible transport scenarios of unit loads 14 through the intralogistics system 10. This calculation can be based on most varied information, such as, for example a configuration of an intralogistics system 10 with all its components, configurations, mechanical, electrical and other properties.

Other input parameters can be, for example historical or statistical data from the same intralogistics system 10 or also from other intralogistics systems 10 of other customers and/or other sites. Further information can be based, for example, on order data and thus take into account influences of specific historical or current order structures, such as, for example, number of items, article size, article weight, surface properties and suchlike. In accordance with one example, the determining of the transport times by the simulation unit 44 is performed using a learning system, for example on the basis of artificial neural networks.

The simulation unit 44 can have a processor along with the known and required peripheral components such as storage media, interfaces and other components, wherein the simulation unit 44 is configured to execute the method presented. The steps of the method 100 need not necessarily be executed by one and the same entity; rather, a simulation unit 44 can comprise different computer entities, which can also be arranged physically separate. For example, a provisioning sequence of unit loads 14 can be executed on a separate computer or simulation unit 44. For example, also steps which require a higher performance of hardware or software can be executed in a centralized system.

FIG. 9 features the difficulty of determining a picking performance 34 to be expected of a picker 32. FIG. 9 shows a picking performance determination unit for determining a picking performance 34 of a picker 32 at a specific point in time. It is generally desirable to be able to forecast a future picking performance 34 with sufficient accuracy in order to then be able to calculate an optimization of the delivery of unit loads 14 on that basis. As a technical requirement, a simulation unit 44 is provided to this end which executes, for example, a mathematical projection for future periods of time using historical picking performance data 64.

FIG. 9 shows an example of a picking performance determination unit for determining a picking performance 34 of a picker 32 at a specific point in time, wherein predefined picking performance profiles 66 are made available in a database. Such a picking performance profile 66 can describe a finite number of typical developments of picking performances 34 of a picker 32 over time. The limiting of the number of such profiles can be advantageous from the perspective of a more effective calculation, as it reduces the complexity of a calculation method and increases a speed of the calculation.

An artificial intelligence module, AI module 68 in short, is configured to divide, assess and/or classify historical picking performance data 64 and/or current picking performance data 65, which are acquired from the picking data processing system using a picking performance data acquisition module, into the above-mentioned picking performance profiles 66 using a trained machine learning model, in particular an artificial neural network. Instead of a trained artificial neural network, the AI module 68 can also support other suitable methods of machine learning, including reinforcement learning, unsupervised learning, semi-supervised learning, self-supervised learning and/or supervised learning, and/or be composed by a combination of multiple approaches from the above sub-fields of machine learning. In accordance with one example, the determining of a specific picking performance 34 of a picker 32 at a specific point in time can be performed on the basis of the previously determined picking performance profiles 66, in particular previously determined by classification or forecasting, with a specified period of time or point in time as an input parameter. To this end, the simulation unit can have a suitable timer (not represented in more detail) or receive suitable time data.

Table of reference numbers

| | |
|---|---|
| 10 | intralogistics system |
| 12 | goods receipt |
| 14 | unit load |
| 16 | delivery vehicles |
| 18 | rack systems |
| 19 | storage rack |
| 20 | storage and retrieval unit |
| 22 | mobile transport system |
| | (conveying system) |
| 24 | stationary transport system |
| | (conveying system) |
| 26 | picking workstation |
| 27 | goods issue |
| 28 | shipping package |
| 30 | outbound conveying system |
| 32 | picker (picker) |
| 34 | picking performance of a |
| | picker |
| 36 | provisioning performance of |
| | unit loads in front of a picking work- |
| | station |
| 38 | resultant performance of the |
| | overall system |
| 40 | jamming situation |
| 42 | idling situation |
| 44 | simulation unit |
| 50 | buffer device |
| 52 | buffer position |
| 54 | buffer location |
| 56 | unit load manipulation unit |
| 62 | transport time of a unit load |
| 64 | historical picking performance data |
| 65 | current picking performance data |
| 66 | picking performance profile |
| 68 | AI module |
| 100 | method for optimizing a |
| | provisioning of unit loads at a |
| | picking workstation |
| 110 | determining transport times |
| 120 | determining a picking performance |
| | to be expected |
| 130 | calculating a future |
| | provisioning sequence of unit loads |
| 140 | calculating a unit load placement of |
| | the buffer device with availability |
| | time |

What is claimed is:

1. A computer-implemented method for optimizing a provisioning of unit loads at a picking workstation of an intralogistics system, the intralogistics system having a buffer device for temporarily storing unit loads, a conveying system for conveying unit loads between the buffer device and the picking workstation and a unit load manipulation unit configured to receive unit loads from the buffer device and deliver unit loads to the conveying system,
wherein at the picking workstation picking orders consisting of individual picking work steps are processed by a picker, and
wherein the method comprises the steps:
determining, with a simulation unit, transport times of unit loads from buffer positions of the buffer device to the picking workstation of the intralogistics system,
determining, with the simulation unit, a picking performance to be expected on the basis of historic picking performance data, wherein the picking performance indicates a processing of the picking orders by the picker at the picking workstation per unit of time,
calculating, by the simulation unit, a future provisioning sequence of unit loads with the respective points in time of provisioning the unit loads at the picking workstation for a picking work step on the basis of the previously determined picking performance to be expected, wherein the calculating is performed such that one of the unit loads is assigned a point in time of provisioning at the picking workstation such that an amount of a time difference between a point in time of a conclusion of the preceding picking work step and the point in time of provisioning the one of the unit loads is minimized,
calculating, by the simulation unit, a unit load placement of the buffer positions of the buffer device with the associated points in time of availability, on the basis of the determined transport times of the unit loads and the calculated provisioning sequence with the points in time of provisioning at the picking workstation.

2. The method according to claim 1, further comprising the step:
recommending an adaptation of a transport process for provisioning the unit loads at the buffer positions of the buffer device in order to provision the calculated unit load placement.

3. The method according to claim 1, wherein the provisioning sequence is further calculated, so that a number of unit loads of a same order to be provisioned in direct succession at the picking workstation is maximized.

4. The method according to claim 1, wherein the determining of a picking performance to be expected of the picking workstation is performed by forecasting using the simulation unit.

5. The method according to claim 4, further comprising the step:
receiving data relating the picking performance of the picker at the picking workstation at a plurality of points in time in order to determine an actual picking performance, wherein the forecasting is based on an analysis of a development over time of the actual picking performance of the picking workstation.

6. The method according to claim 4, wherein the forecasting of the picking performance is performed on the basis of picking performance profiles stored in a computer system, wherein the picking performance profiles are generated using a model of machine learning, in particular an artificial neural network.

7. The method according to claim 6, wherein the method comprises the step of:
selecting a picking performance profile from a plurality of deposited picking performance profiles by classifying acquired picking performance data using a trained model of machine learning, in particular an artificial neural network.

8. The method according to claim 7, wherein the selecting is performed such that a deviation of the selected picking performance profile from the development over time of the actual picking performance is minimized.

9. The method according to claim 1, wherein the determining of the picking performance to be expected is executed also on the basis of article metadata of the articles in the respective picking order.

10. The method according to claim 1, further comprising the step:
creating a manipulation specification for a control unit of the unit load manipulation unit for receiving unit loads from the buffer positions of the buffer device and delivering unit loads to the conveying system for conveying unit loads to the picking workstation.

11. The method according to claim 10, wherein the creating of the manipulation specification comprises:
generating a start signal for the control unit of the unit load manipulation unit for receiving a unit load from one of the buffer positions of the buffer device, and/or
changing a dynamic of the unit load manipulation unit, and/or
changing or specifying a moving sequence, in which the unit load manipulation unit is to move at the buffer positions.

12. The method according to claim 1, further comprising the step:
provisioning the calculated occupation of the buffer positions of the buffer device with the associated points in time of occupation to a control unit for transport vehicles of the intralogistics system, wherein the control unit for transport vehicles of the intralogistics system is configured to control a retrieval of unit loads from a storage area of the intralogistics system such that the unit loads are available at the calculated buffer positions of the buffer device at the calculated points in time of occupation.

13. An intralogistics system, comprising:
a storage area for unit loads,
a plurality of transport vehicles operated in an automated manner,
a buffer device with a plurality of buffer positions for receiving unit loads previously retrieved from the storage area,
a unit load manipulation unit,
a conveying system,
one or multiple picking workstations, wherein at each picking workstation picking orders consisting of individual picking work steps are processed by a respective picker, and
a simulation unit configured
to determine transport times of unit loads from a buffer position of the buffer device to one of the picking workstations of the intralogistics system,
to determine a picking performance to be expected on the basis of historic picking performance data, wherein the picking performance indicates a processing of the picking orders by the picker at the picking workstation per unit of time,
to calculate a future provisioning sequence of unit loads with the respective points in time of provisioning the unit loads at the picking workstation for a picking work step on the basis of the previously determined expected picking performance, wherein the calculating is performed such that one of the unit loads is assigned a point in time of provisioning at the picking workstation such that an amount of a time difference between a point in time of a conclusion of the preceding picking work step and the point in time of provisioning the one of the unit loads is minimized, and
to calculate a unit load placement of the buffer positions of the buffer device with the associated points in time of availability, on the basis of the determined transport times of the unit loads and the calculated provisioning sequence with the points in time of provisioning at the picking workstation,
wherein the transport vehicles are configured to transport unit loads between the storage and the buffer positions,
wherein the unit load manipulation unit is configured to receive unit loads from buffer positions of the buffer device and to deliver unit loads to the conveying system, and
wherein the conveying system is configured to transport unit loads between the unit load manipulation unit and the picking workstation.

14. The intralogistics system according to claim 13, wherein the buffer device is arranged between the storage area and the unit load manipulation unit.

15. The intralogistics system according to claim 13, wherein the storage area has storage levels located on top of one another, which form receiving locations for unit loads arranged respectively next to one another, and the buffer positions are arranged on top of one another, wherein at least one storage level is assigned to each of the buffer positions and wherein each of the buffer positions is formed by a provisioning device.

16. The intralogistics system according to claim 13, wherein the unit load manipulation unit has a unit load lifting device, which comprises a vertically mobile transport device for receiving one or multiple unit loads.

17. The intralogistics system according to claim 13, wherein the buffer device is provided such that the unit load manipulation unit can access each buffer position of the buffer device at a given point in time.

18. A computer-implemented method for optimizing a provisioning of unit loads at a picking workstation of an intralogistics system, the intralogistics system having a buffer device for temporarily storing unit loads, a conveying system for conveying unit loads between the buffer device and the picking workstation and a unit load manipulation unit configured to receive unit loads from the buffer device and deliver unit loads to the conveying system,
wherein at a picking workstation picking orders are processed by a picker, and
wherein the method comprises the steps of:
determining, with a simulation unit, transport times of unit loads from buffer positions of the buffer device to the picking workstation of the intralogistics system,
determining, with the simulation unit, a picking performance to be expected on the basis of historic picking performance data,
calculating, by the simulation unit, a future provisioning sequence of unit loads with the respective points in time of provisioning the unit loads at the picking workstation for a picking work step on the basis of the previously determined picking performance to be expected, and
calculating, by the simulation unit, a unit load placement of the buffer positions of the buffer device with the associated points in time of availability.
